(19) United States
(12) Patent Application Publication
(10) Pub. No.: US 2009/0090330 A1
(43) Pub. Date: Apr. 9, 2009

(54) Fuel pump control device

(75) Inventors: Mamoru Tateishi, Kariya-shi (JP); Tetsuji Inoue, Nagoya-shi (JP)

Correspondence Address: OLIFF & BERRIDGE, PLC, P.O. BOX 320850, ALEXANDRIA, VA, 22320-4850, US

(73) Assignee: AISAN KOGYO KABUSHIKI KAISHA, Obu-Shi (JP)

(21) Appl. No.: 12/222,362

(22) Filed: Aug. 7, 2008

(30) Foreign Application Priority Data
Oct. 5, 2007 (JP) 2007-261825

(51) Int. Cl. F02D 31/00

(52) U.S. Cl. 123/357; 123/519

(57) ABSTRACT

A fuel pump control device including an electric component for controlling a fuel pump is placed in a fuel tank. The electric component is hermetically enclosed in a housing. An adsorbent of a cartridge type for adsorbing fuel vapor is provided in the housing. The housing includes a housing body and a covering member closing an opening of the housing body. The electric component includes a control circuit unit and an external terminal extending from the control circuit unit. The external terminal is provided passing through the covering member to the outside. The adsorbent is charged between the covering member and the control circuit unit so that the external terminal is placed passing through the adsorbent.

### BACKGROUND OF THE INVENTION

1. Field of the Invention

The present invention relates to a fuel pump to be used for supplying fuel to an engine and more particularly to a fuel pump control device for controlling the fuel pump.

2. Description of Related Art

Heretofore, one technique of this type is disclosed in JP2001-214826A. Specifically, JP'826A discloses an in-tank fuel pump including a pump body placed in a fuel tank.

As to the in-tank fuel pump disclosed in JP2001-214826A, it is conceivable to provide a control device (a controller or the like) for pump in the fuel tank. In this case, however, fuel vapor generated in the fuel tank is likely to cause damage leading to malfunction to an electric component of the control device.

### BRIEF SUMMARY OF THE INVENTION

The present invention has been made in view of the above circumstances and has an object to provide a fuel pump control device capable of protecting an electric component from damage caused by fuel vapor even when placed in a fuel tank.

Additional objects and advantages of the invention will be set forth in part in the description which follows and in part will be obvious from the description, or may be learned by practice of the invention. The objects and advantages of the invention may be realized and attained by means of the instrumentalities and combinations particularly pointed out in the appended claims.

To achieve the purpose of the invention, there is provided a fuel pump control device including an electric component for controlling a fuel pump, at least part of the control device being to be placed in a fuel tank, the control device comprising: a housing in which the electric component is housed; and an adsorbent provided in the housing to adsorb fuel vapor.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention.

In the drawings,

FIG. 1 is a sectional view of a fuel pump control device of a first embodiment;

FIG. 2 is a side view showing a state where a pump module including the control device is mounted in a fuel tank in the first embodiment;

FIG. 3 is a sectional view of a fuel pump control device of a second embodiment;

FIG. 4 is a sectional view of a fuel pump control device of a third embodiment;

FIG. 5 is a sectional view of a fuel pump control device of a fourth embodiment;

FIG. 6 is a sectional view of a fuel pump control device of a fifth embodiment;

FIG. 7 is a sectional view of a fuel pump control device of a sixth embodiment;

FIG. 8 is a partly-sectional side view showing a state where a pump module including a control device is mounted in a fuel tank in a seventh embodiment;

FIG. 9 is a partly-sectional side view showing a state where a pump module including a control device is mounted in a fuel tank in an eighth embodiment; and

FIG. 10 is a sectional view of a fuel pump control device of another embodiment.

### DETAILED DESCRIPTION OF THE PREFERRED EMBODIMENTS

### First Embodiment

A detailed description of a preferred first embodiment of a fuel pump control device embodying the present invention will now be given referring to the accompanying drawings.

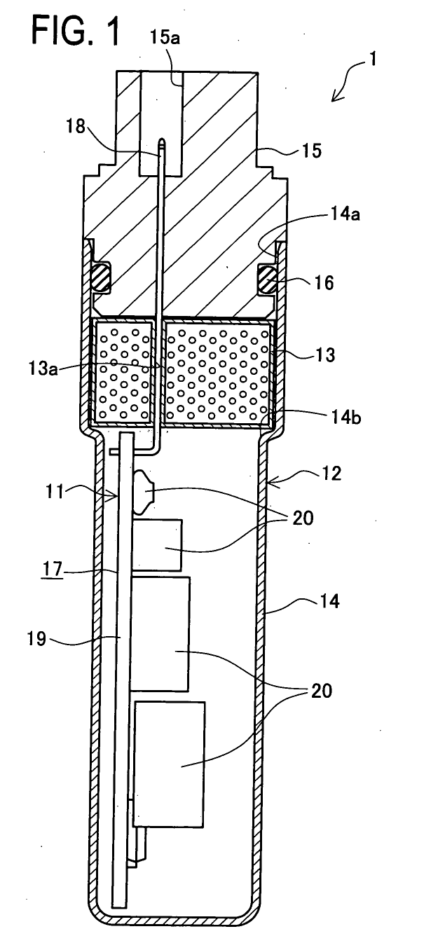

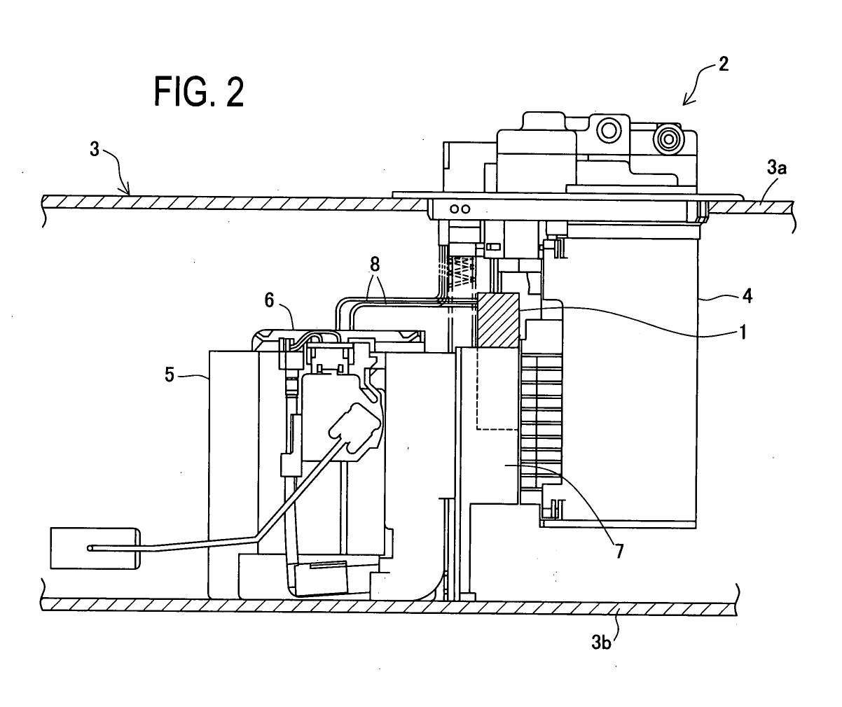

FIG. 1 is a sectional view of a fuel pump control device 1 (hereinafter, simply referred to as a “control device”) of this embodiment. FIG. 2 is a side view showing a state where a pump module 2 including the control device 1 is mounted in a fuel tank 3.

As shown in FIG. 2, the pump module 2 mounted in the fuel tank 3 comprises a canister 4, a reserve cup 5, a fuel pump 6, and the control device 1. The canister 4 internally contains an adsorbent such as activated charcoal to adsorb fuel vapor generated in the fuel tank 3 once. The canister 4 and the reserve cup 5 are connected to each other through a connection member 7. The canister 4 is attached to an upper wall 3a of the fuel tank 3 with an upper part of the canister 4 protruding upward through the upper wall 3a. The reserve cup 5 is configured to reserve part of fuel in the fuel tank 3. The reserve cup 5 is placed in contact with a lower wall 3b of the fuel tank 3. The fuel pump 6 is set in place in the reserve cup 5. The control device 1 is held between connecting portions of the canister 4 and the reserve cup 5 and fixed to the connection member 7. Harnesses 8 extending from the control device 1 are electrically connected to the fuel pump 6.

The control device 1 placed in the fuel tank 3 includes an electric component 11 for controlling the fuel pump 6 as shown in FIG. 1. The electric component 11 is hermetically enclosed in the housing 12. In this housing 12, furthermore, an adsorbent 13 is placed to adsorb fuel vapor.

As shown in FIG. 1, the housing 12 includes a metallic housing body 14 of a bottom-closed cylindrical shape and a resin covering member 15 for closing an opening 14a of the housing body 14. The covering member 15 is fitted in the opening 14a, interposing therebetween a seal member 16 such as an O-ring provided on the periphery of the covering member 15 or an adhesive seal. The covering member 15 is formed, on its top, with a connector hole 15a for connection with the external harnesses 8.

The electric component 11 includes a control circuit unit 17 and an external terminal 18 extending from the control circuit unit 17. The control circuit unit 17 is constituted of a plurality of circuit elements 20 arranged on a substrate 19. The control circuit unit 17 is provided with a circuit configuration for controlling the fuel pump 6. In this embodiment, the outer surface of the control circuit unit 17 is entirely coated with a coating material (not shown). This coating material used in this embodiment is “rubber or fluorocarbon adhesive”. With this coating material, the circuit element 20 and others can be protected. The external terminal 18 extends from the substrate 19, passing through the covering member 15, to the outside. The adsorbent 13 is charged in the space between the covering member 15 and the control circuit unit 17. The adsorbent 13 used in this embodiment is “activated charcoal such as palm shells, coal, and wood coal”. The adsorbent 13 is provided as a cartridge, specifically, in the form of a cartridge previously compressed into a columnar shape. The housing body 14 is formed on an upper part with a shoulder portion 14b made by partly decreasing outer and inner diameters. The adsorbent 13 is held on this shoulder portion 14b. The external terminal 18 is placed passing through a hole 13a formed in the adsorbent 13 so that a distal end of the external terminal 18 protrudes into the connector hole 15a of the covering member 15.

In this embodiment, the external terminal 18 is insert-molded in the covering member 15. Concretely, when the covering member 15 is to be made by resin molding, the external terminal 18 is set as an insert in a molding die and resin molded integral with the covering member 15. Prior to the insert molding, the outer surface of the external terminal 18 is coated with a primer (not shown). The primer exhibits a seal function when it is interposed between the covering member 15 and the external terminal 18 after the insert molding. In other words, it is possible to prevent fuel vapor from entering the housing 12 through a gap between the external terminal 18 and the covering member 15. The primer used in this embodiment is a “nitryl rubber adhesive”. Since the external terminal 18 is insert-molded in the covering member 15 as above, the adsorbent 13, the control circuit unit 17, the external terminal 18 and the covering member 15 are assembled together before they are inserted in the housing body 14. To be concrete, the external terminal 18 insert-molded in the covering member 15 is inserted in the adsorbent 13 and then a proximal end of the external terminal 18 is fixedly connected to the substrate 19 of the control circuit unit 17. Such assembly of the components 13, 15, 17, and 18 is inserted in the housing body 14 in order of the control circuit unit 17 and the adsorbent 13, and finally the covering member 15 is fitted in the opening 14a of the housing body 14. The control device 1 shown in FIG. 1 can be manufactured in the above steps.

The control device 1 of this embodiment described above is placed in the fuel tank 3 and hence will be exposed to the atmosphere of fuel vapor. In case the fuel vapor enters the housing 12 through a gap between sealing areas of the covering member 15 and the opening 14a of the housing body 14, the fuel vapor will be adsorbed and trapped by the adsorbent 13. Thus, the fuel vapor is unlikely to touch the electric component 11. The electric component 11 can therefore be protected from damage caused by the fuel vapor.

In this embodiment, a part of the external terminal 18 surrounded by the adsorbent 13 is protected by the adsorbent 13. This makes it possible to enhance the durability of the external terminal 18. The adsorbent 13 formed as a cartridge in this embodiment is easy to handle singly and can readily be inserted and charged in the housing 12. In this regard, the adsorbent 13 contributes to simplification of manufacture of the control device 1.

### Second Embodiment

Next, a second embodiment of a fuel pump control device according to the present invention will be described in detail referring to the accompanying drawing.

In each subsequent embodiment mentioned below, the same or similar components as those in the first embodiment are given the same reference signs and their details are omitted. The following explanation is focused on differences from the first embodiment.

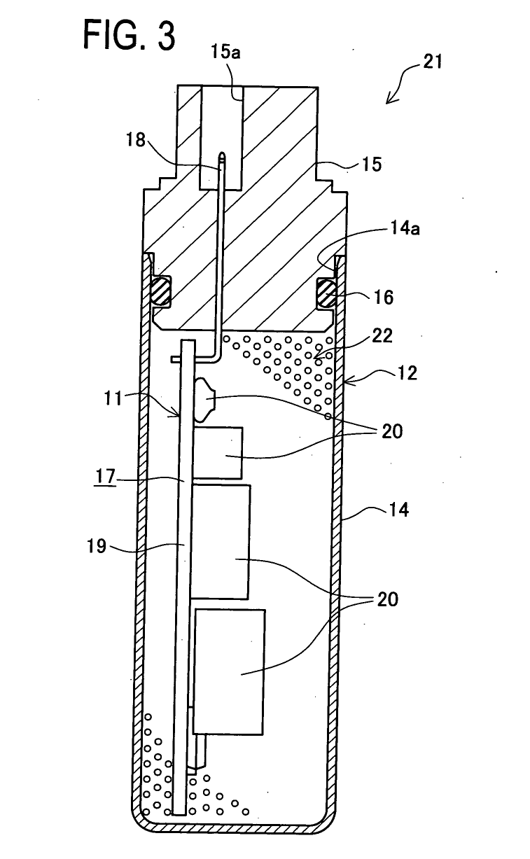

FIG. 3 is a sectional view of a fuel pump control device 21 of the second embodiment. This embodiment differs from the first embodiment in the configuration of an adsorbent 22. In this embodiment, specifically, the uncompressed, granular adsorbent 22 is used instead of the adsorbent 13 of a cartridge form. The granular adsorbent 22 is charged throughout the space around the control circuit unit 17 in a sealed area of the housing 12. Other configurations are basically identical to those in the first embodiment.

This embodiment can also provide the same operations and advantages as in the first embodiment. In this embodiment, particularly, the control circuit unit 17 is surrounded and hence protected by the granular adsorbent 22. The durability of the control circuit unit 17 can therefore be enhanced.

### Third Embodiment

A third embodiment of a fuel pump control device according to the present invention will be described in detail referring to the accompanying drawing.

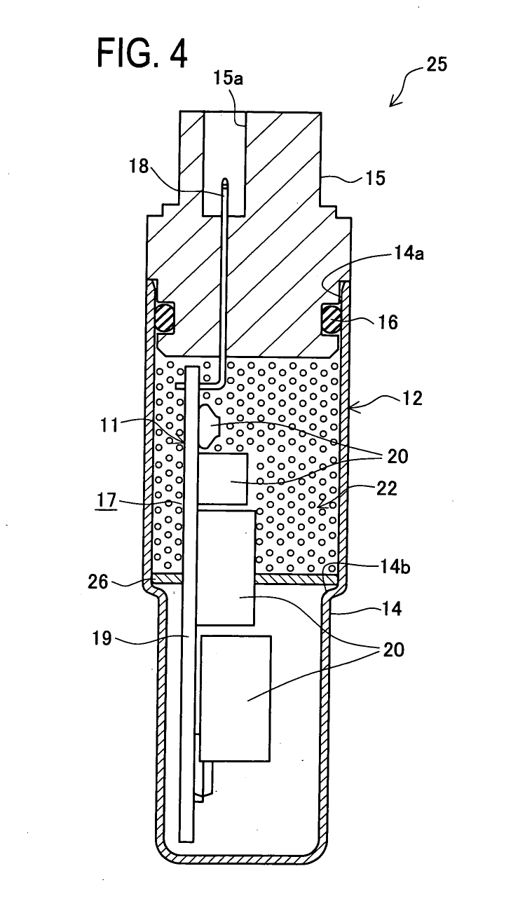

FIG. 4 is a sectional view of a fuel pump control device 25 of the third embodiment. This embodiment differs from the second embodiment in the configuration of the adsorbent 22. In this embodiment, unlike the second embodiment, specifically, the granular adsorbent 22 is charged in the space around an upper half of the control circuit unit 17 in the housing 12. A partition plate 26 is placed at a midpoint of the housing body 14 so that the granular adsorbent 22 is charged in the space defined by the partition plate 26 and the covering member 15. At the midpoint of the housing body 14, a shoulder portion 14b is formed on which the partition plate 26 is held.

Consequently, this embodiment can also provide the same operations and advantages as in the second embodiment. In this embodiment, particularly, the filling amount of adsorbent 22 can be economically reduced to half as compared with that in the second embodiment.

### Fourth Embodiment

A fourth embodiment of a fuel pump control device according to the present invention will be described in detail referring to the accompanying drawing.

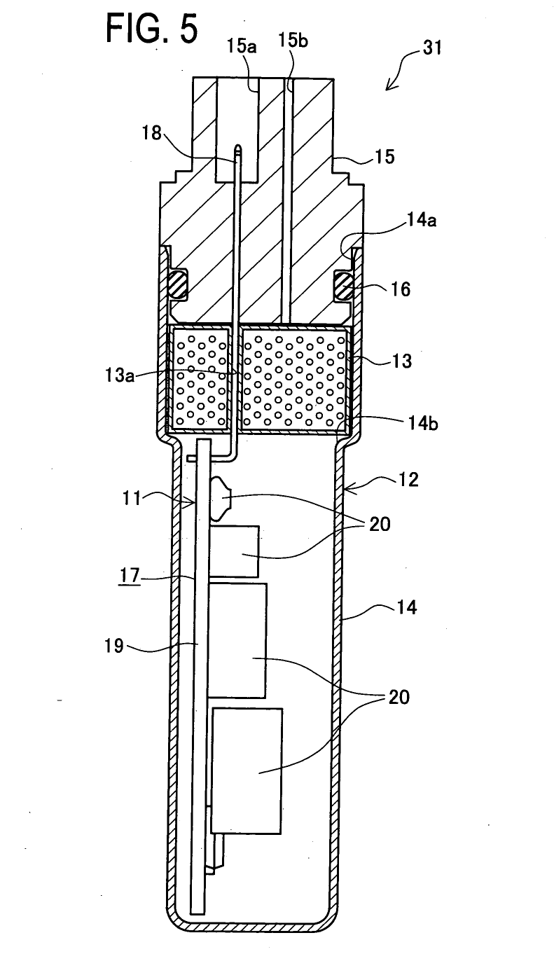

FIG. 5 is a sectional view of a fuel pump control device 31 of the fourth embodiment. This embodiment differs from the first embodiment in the configuration of the covering member 15. In this embodiment, specifically, the covering member 15 is formed with a vent slot 15b. Thus, the housing 12 includes the vent slot 15b communicating with the outside.

Accordingly, in addition to the same operations and advantages as in the first embodiment, the fourth embodiment in which the inside of the housing 12 communicates with atmosphere through the vent slot 15b can prevent the internal pressure in the housing 12 from becoming higher than the atmospheric pressure. It is therefore possible to prevent the internal pressure in the housing 12 from abnormally rising than saturated vapor pressure of the fuel vapor, thereby facilitating adsorption of fuel vapor to the adsorbent 13.

### Fifth Embodiment

A fifth embodiment of a fuel pump control device according to the present invention will be described in detail referring to the accompanying drawing.

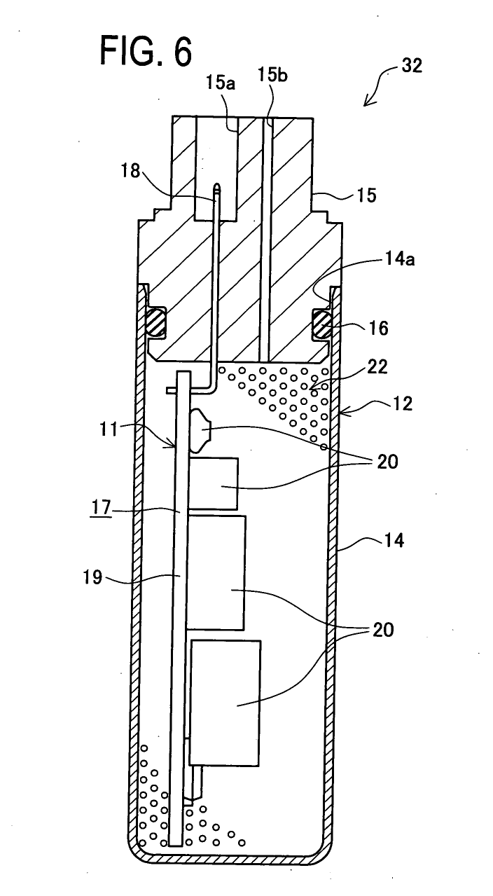

FIG. 6 is a sectional view of a fuel pump control device 32 of the fifth embodiment. This embodiment differs from the second embodiment in the configuration of the covering member 15. In this embodiment, similarly, the vent slot 15b is formed in the covering member 15. Thus, the housing 12 includes the vent slot 15b communicating with the outside.

Accordingly, in addition to the same operations and advantages as in the second embodiment, the fifth embodiment in which the inside of the housing 12 communicates with atmosphere through the vent slot 15b can prevent the internal pressure in the housing 12 from becoming higher than the atmospheric pressure. It is therefore possible to prevent the internal pressure in the housing 12 from abnormally rising than saturated vapor pressure of the fuel vapor, thereby facilitating adsorption of fuel vapor to the adsorbent 22.

### Sixth Embodiment

A sixth embodiment of a fuel pump control device according to the present invention will be described in detail referring to the accompanying drawing.

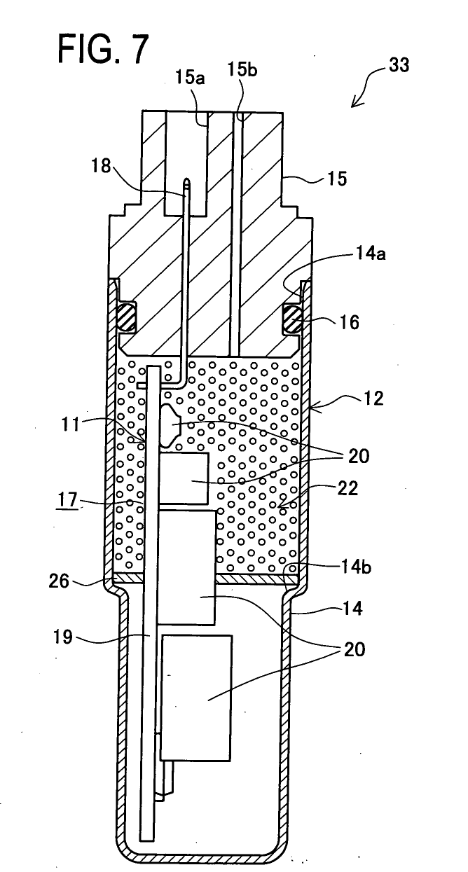

FIG. 7 is a sectional view of a fuel pump control device 33 of the sixth embodiment. This embodiment differs from the third embodiment in the configuration of the covering member 15. In this embodiment, similarly, the vent slot 15b is formed in the covering member 15. Thus, the housing 12 includes the vent slot 15b communicating with the outside.

Accordingly, in addition to the same operations and advantages as in the third embodiment, the sixth embodiment in which the inside of the housing 12 communicates with atmosphere through the vent slot 15b can prevent the internal pressure in the housing 12 from becoming higher than the atmospheric pressure. It is therefore possible to prevent the internal pressure in the housing 12 from abnormally rising than saturated vapor pressure of the fuel vapor, thereby facilitating adsorption of fuel vapor to the adsorbent 22.

### Seventh Embodiment

A seventh embodiment of a fuel pump control device according to the present invention will be described in detail referring to the accompanying drawing.

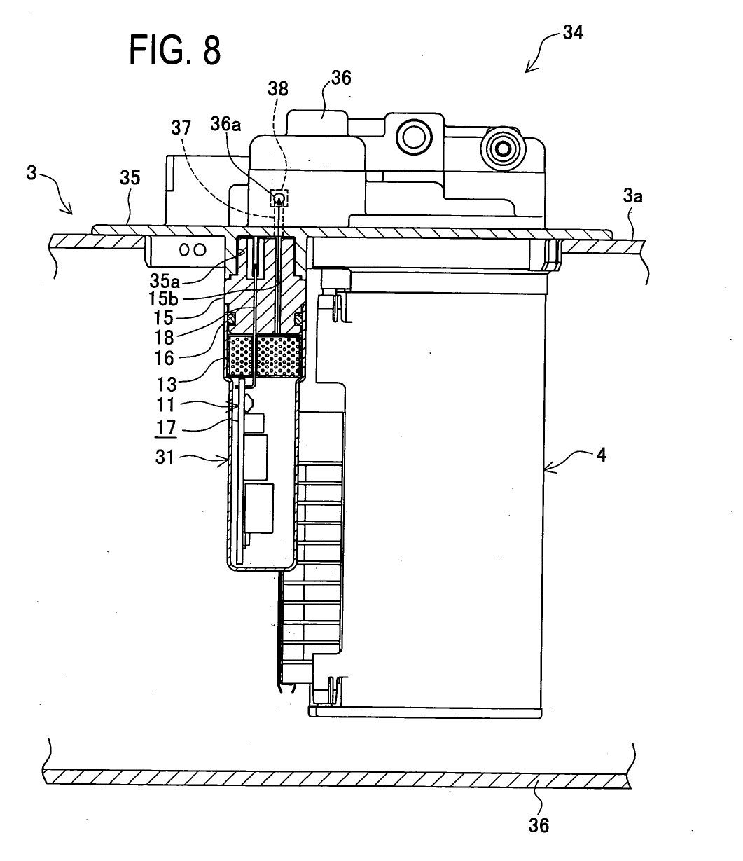

FIG. 8 is a partly-sectional side view a state where a pump module 34 including the fuel pump control device 31 of this embodiment is mounted in the fuel tank 3. In FIG. 8, the reserve cup 5, the fuel pump 6, and the connection member 7 are not illustrated for the same of convenience. This embodiment differs from the fourth embodiment in the configuration that the fuel pump control device 31 is attached to the inside (a lower-surface side) of a mounting plate 35 set on the upper wall 3a of the fuel tank 3. The mounting plate 35 is a member for attaching the pump module 34 to the fuel tank 3. The canister 4 is supported on the inner side of the mounting plate 35. The control device 31 is fixed to the mounting plate 35 so that the covering member 15 is inserted under pressure in a mounting hole 35a formed on the inner side of the mounting plate 35. Specifically, the covering member 15 is fixed in the mounting hole 35a by hot-plate welding or adhesive. A cover 36 integral with the mounting plate 35 is formed with a vent hole 36a communicating with the outside. The mounting plate 35 is provided with a communication tube 37 having one open end communicating with the vent slot 15b of the control device 31. The other open end of the communication tube 37 communicates with the vent hole 36a through a filter 38 placed inside the cover 36. The filter 38 has a property of allowing passage of water vapor and inhibiting passage of water drop.

Accordingly, in addition to the same operations and advantages as in the fourth embodiment, the sixth embodiment in which the control device 31 is fixed to the inner side of the mounting plate 35 can made the pump module 34 including the control device 31 compact as compared with in the fourth embodiment. Furthermore, the vent slot 15b of the control device 31 communicates with the outside through the communication tube 37, the filter 38, and the vent hole 36a, so that the liquid containing fuel components is unlikely to leak to the outside through the vent hole 36a.

### Eighth Embodiment

An eighth embodiment of a fuel pump control device according to the present invention will be described in detail referring to the accompanying drawing.

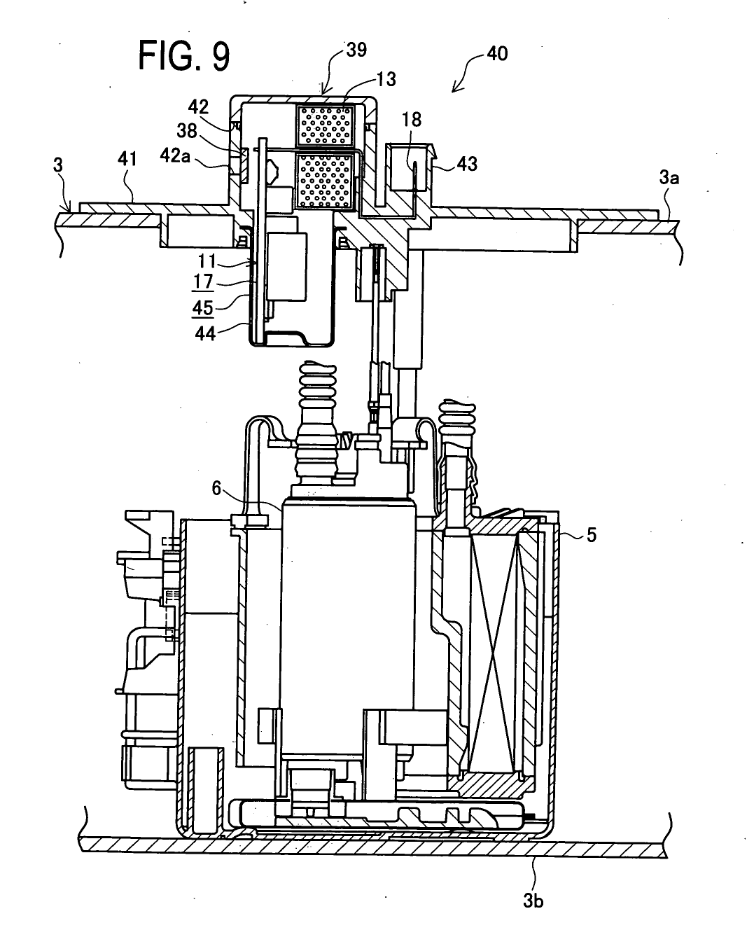

FIG. 9 is a partly-sectional side view a state where a pump module 40 including a fuel pump control device 39 of the eighth embodiment is mounted in the fuel tank 3. The pump module 40 of this embodiment is a type with no canister, unlike those in the aforementioned embodiments. The pump module 40 includes a mounting plate 41, the reserve cup 5 supported by the mounting plate 41, the fuel pump 6 placed in the reserve cup 5, and others. In this embodiment, the control device 39 is provided integral with the mounting plate 41. Concretely, the mounting plate 41 is integrally formed with a case 42 and a connector 43, both protruding upward on the outer side (the upper surface side). Besides, on the outer side of the mounting plate 41, other parts (not shown) related to the fuel pump 6 and others are arranged. On the inner side of the mounting plate 41, a metal cup 44 is attached in correspondence with the case 42. This cup 44 is located in the fuel tank 3. The inside of the cup 44 communicates with the inside of the case 42. The cup 44 is insert-molded with the mounting plate 41. In this embodiment, the case 42 and the cup 44 constitute a housing 45 of the control device 39. In this housing 45, the electric component 11 and the adsorbent 13 are housed. The electric component 11 is fixed to the cup 44 and the adsorbent 13 is fixed to the case 42. The external terminal 18 extending from the control circuit unit 17 is provided passing through the adsorbent 13 so that a distal end protrudes in the connector 43. The case 42 is formed with a vent hole 42a communicating with the outside of the case 42. A filter 38 is placed on the inner side of the case 42 to cover the vent hole 42a.

Accordingly, the fuel pump control device 39 of this embodiment can also provide the same operations and advantages as in the aforementioned embodiments in relation to the adsorbent 13 housed in the housing 45. In this embodiment, additionally, the control device 39 is provided integral with the mounting plate 41, and the case 42 integral with the mounting plate 41 constitutes the housing 45. Thus, the control device 39 can be designed compact in the pump module 40. The case 42 constituting the housing 45 protrudes upward from the mounting plate 41 and similarly other components protrude upward from the mounting plate 41. Therefore, protrusion of the case 42 of the control device 39 will not cause any problem in loading the fuel tank 3 in a vehicle. Only a small part of the control device 39, i.e., the cup 44 is placed in the fuel tank 3, thus reducing interference with the reserve cup 5 and the fuel pump 6. With the filter 38 provided over the vent hole 42a of the case 42, the liquid containing fuel components and others is unlikely to leak to the outside through the vent hole 42a.

The present invention is not limited to the above embodiment(s) and may be embodied in other specific forms without departing from the essential characteristics thereof.

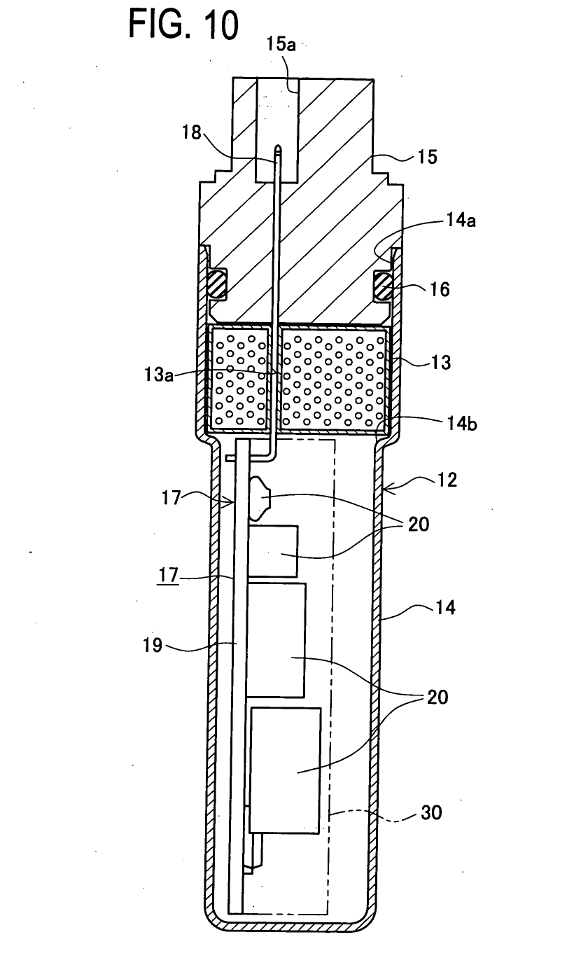

For instance, in the first embodiment, the outer surface of the control circuit unit 17 is entirely coated with the coating material. As shown in FIG. 10, the control circuit unit 17 may be covered by the case 30 instead of the coating material or in addition to application of the coating material. The same changes as above may be applied to the second to eighth embodiments.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A fuel pump control device including an electric component for controlling a fuel pump, at least part of the control device being to be placed in a fuel tank, the control device comprising:
a housing in which the electric component is housed; and
an adsorbent provided in the housing to adsorb fuel vapor.

2. The fuel pump control device according to claim 1, wherein
the adsorbent is provided in a sealed area of the housing and is charged in the housing so as to surround at least part of the electric component.

3. The fuel pump control device according to claim 1, wherein
the housing includes a housing body of a bottom-closed cylindrical shape and a covering member closing an opening of the housing body,
the electric component includes a control circuit unit and an external terminal extending from the control circuit unit,
the external terminal is provided passing through the covering member to extend to the outside, and
the adsorbent is charged between the covering member and the control circuit unit so that the external terminal is placed passing through the adsorbent.

4. The fuel pump control device according to claim 2, wherein
the housing includes a housing body of a bottom-closed cylindrical shape and a covering member closing an opening of the housing body,
the electric component includes a control circuit unit and an external terminal extending from the control circuit unit,
the external terminal is provided passing through the covering member to extend to the outside, and
the adsorbent is charged between the covering member and the control circuit unit so that the external terminal is placed passing through the adsorbent.

5. The fuel pump control device according to claim 3, wherein the control unit is covered by a case.

6. The fuel pump control device according to claim 1, wherein the adsorbent is formed of a cartridge.

7. The fuel pump control device according to claim 2, wherein the adsorbent is formed of a cartridge.

8. The fuel pump control device according to claim 3, wherein the adsorbent is formed of a cartridge.

9. The fuel pump control device according to claim 3, wherein
the adsorbent is formed of a cartridge, and
the housing body is formed, on an upper part, with a shoulder portion on which the adsorbent is held.

10. The fuel pump control device according to claim 4, wherein
the adsorbent is formed of a cartridge, and
the housing body is formed, on an upper part, with a shoulder portion on which the adsorbent is held.

11. The fuel pump control device according to claim 3, wherein
the housing body is formed, at a midpoint, with a shoulder portion on which a partition wall is held, and
the adsorbent is charged in a space around an upper half of the control circuit unit and between the partition wall and the covering member.

12. The fuel pump control device according to claim 4, wherein
the housing body is formed, at a midpoint, with a shoulder portion on which a partition wall is held, and
the adsorbent is charged in a space around an upper half of the control circuit unit and between the partition wall and the covering member.

13. The fuel pump control device according to claim 11, wherein the control unit is covered by the case.

14. The fuel pump control device according to claim 1, wherein
the housing includes a housing body of a bottom-closed cylindrical shape and a covering member closing an opening of the housing body,
the electric component includes a control circuit unit and an external terminal extending from the control circuit unit,
the external terminal is provided passing through the covering member to extend to the outside, and
the adsorbent is charged throughout a space around the control circuit unit in the housing.

15. The fuel pump control device according to claim 14, wherein the control unit is covered by the case.

16. The fuel pump control device according to claim 1, wherein the housing is hermetically closed.

17. The fuel pump control device according to claim 1, wherein the housing includes a vent hole communicating with the outside.

18. The fuel pump control device according to claim 3, wherein the housing includes a vent hole communicating with the outside.

19. The fuel pump control device according to claim 9, wherein the housing includes a vent hole communicating with the outside.

20. The fuel pump control device according to claim 11, wherein the housing includes a vent hole communicating with the outside.
